(19) United States
(12) Patent Application Publication
(10) Pub. No.: US 2026/0177373 A1
(43) Pub. Date: Jun. 25, 2026

(54) METHOD AND DEVICE FOR OPTICAL MEASUREMENT

(71) Applicant: Klingelnberg GmbH, Hückeswagen (DE)

(72) Inventor: Johannes Lüdenbach, Engelskirchen (DE)

(21) Appl. No.: 19/414,547

(22) Filed: Dec. 10, 2025

(30) Foreign Application Priority Data
Dec. 19, 2024 (EP) 24221950.9

(51) Int. Cl. G01B 11/00

(52) U.S. Cl. CPC G01B 11/005

(57) ABSTRACT

A method including the steps of: measuring a component using an optical distance sensor of a coordinate measuring machine, wherein a measuring path is traversed using a measurement movement; and controlling a distance between the optical distance sensor and the component during the measurement. The control of the distance includes determining a corrected measurement movement according to a first cycle frequency, and the control of the distance comprises position control for traversing the corrected measurement movement according to a second cycle frequency, wherein the second cycle frequency is greater than the first cycle frequency.

### CROSS-REFERENCE TO RELATED APPLICATIONS

This application claims the benefit of European patent application no. 24221950.9, filed on 19 Dec. 2024, the disclosure of which is incorporated herein by reference in its entirety.

### TECHNICAL FIELD

The present disclosure relates to a method comprising the following steps of: measuring a component using an optical distance sensor of a coordinate measuring machine, wherein a measuring path is traversed by means of a measurement movement.

The disclosure also relates to a device for carrying out such a method.

### BACKGROUND

Optical measurement methods are becoming increasingly important in industrial coordinate measurement technology due to their speed advantage over tactile measurement methods. During optical measurement, it is important to avoid the optical distance sensor colliding with the component to be measured. In addition, it should be ensured that the contour of the component to be measured remains within the measuring range of the optical distance sensor at all times during the measurement.

Publication EP 4 386 313 A1 describes the control of the distance between an optical distance sensor and a component to be measured. Here, a deviation between a target distance to be maintained and a measured actual distance is measured and controlled by means of position control of the optical distance sensor. A disadvantage is that the measured deviation is processed directly in the position control loop of the distance sensor and, depending on the nature of the surface to be measured, this can lead to vibration excitation or oscillation of the optical distance sensor or to vibration excitation or oscillation of an axis carrying the optical distance sensor.

This is because if the contour of the component to be measured has, for example, undulations with a repeating pattern, the position control of the distance sensor immediately follows these undulations. Since position control in coordinate measurement technology is usually performed at high frequencies, these undulations are scanned and tracked at high frequencies, i.e., they are directly transferred to the kinematics of the measurement movement. This can lead to vibration excitation and a resulting impairment of the measurement results.

### SUMMARY

Against this background, the present disclosure is based on the technical problem of specifying an improved method and an improved device for optical measurement, which in particular enable robust and vibration-free position or distance control of an optical distance sensor relative to a component to be measured.

The technical problem described above is solved by the features of the independent claims. Further designs of the disclosure are apparent from the dependent claims and the following description.

According to a first aspect, the disclosure relates to a method comprising the following method steps of: measuring a component using an optical distance sensor of a coordinate measuring machine, wherein a measuring path is traversed by means of a measurement movement; and controlling a distance between the optical distance sensor and the component during the measurement. The method is characterized in that the control of the distance comprises determining a corrected measurement movement according to a first cycle frequency and in that the control of the distance comprises position control for traversing the corrected measurement movement according to a second cycle frequency, wherein the second cycle frequency is greater than the first cycle frequency.

According to the disclosure, the corrected measurement movement is therefore determined with a lower control cycle than the position control. In this way, although an actual distance is adjusted less precisely to a required target distance within the scope of distance control, the influence of periodic surface defects, such as waviness or the like, on the position control can be reduced. Periodic surface profiles, such as waviness or the like, whose frequency is lower than the first cycle frequency, can thus be smoothed by means of the determination of the corrected measurement movement according to the disclosure, or it can be prevented that this waviness is directly transferred to an axis kinematics. Oscillation or vibration excitation, which could occur as a result of precise tracking of such waviness, can thus be avoided. In other words, according to the disclosure, the distance of the optical sensor from a contour to be measured is allowed to follow less precisely in order to avoid vibration excitation. A distance deviation during distance control can therefore be permitted within certain limits in favor of continuous, smooth kinematics of the measurement movements of the coordinate measuring machine.

It can therefore be described as a low-frequency control loop for determining a corrected measurement movement, which transfers these corrected measurement movements to a higher-frequency position control loop.

A measured distance deviation is therefore not transferred directly to the position control, but only has an indirect influence on the position control, specifically via the corrected measurement movement. In other words, the determination of a distance deviation is decoupled from the position control in order to avoid vibration excitation. The corrected measurement movement is therefore performed by the position control independently of the current distance deviation of the optical sensor from a specified target distance to a component contour to be measured. The position control of the optical distance sensor is therefore independent of the current distance deviation. Rather, a distance deviation is accepted in order to avoid vibration excitation.

The second cycle frequency can be greater than or equal to ten times the first cycle frequency. The second cycle frequency can be greater than or equal to twenty-five times the first cycle frequency. The second cycle frequency can be greater than or equal to fifty times the first cycle frequency. The second cycle frequency can be less than or equal to one hundred times the first cycle frequency. The first cycle frequency may be, for example, 20 Hz. The second cycle frequency may be, for example, 1000 Hz.

Determining the corrected measurement movement may involve determining a distance-time profile for a respective cycle of the first cycle frequency, wherein a cycle time of the first cycle is shorter than a time span of the determined distance-time profile, so that a further corrected measurement movement with a further distance-time profile is already determined before the end of the previously determined distance-time profile has been reached.

In other words, it is provided that, during the execution of the corrected measurement movement, the next corrected measurement movement calculated in the low-frequency cycle already transitions into the current movement, e.g., of the sensor axis, so that a smooth, jump-free transition can be created.

The determination of the corrected measurement movement can be carried out by determining correction movements that are superimposed on the measurement movement in order to indicate the corrected measurement movement. This procedure can be useful, for example, when optically measuring a component with a known target geometry, since the measurement movements only need to be adjusted within the range of the expected manufacturing deviations. In this case, correction movements can be determined for a respective cycle of the first cycle frequency, which are superimposed on the measurement movements or previously determined corrected measurement movements in order to define the corrected measurement movements for this cycle.

Alternatively, the determination of the corrected measurement movement can be carried out by replacing the measurement movement with the corrected measurement movement. In this way, the corrected measurement movement is redetermined for each respective cycle of the first cycle frequency. It may be provided that the corrected measurement movements, which follow one another according to the first cycle frequency, are determined to overlap in time, so that a new, corrected measurement movement is already determined before the end of the current corrected measurement movement is reached, and in particular is determined in such a way that successive, corrected measurement movements merge into one another without jumps, i.e., continuously and smoothly. This procedure can be useful, for example, when measuring an unknown contour, i.e., when measuring a component with an unknown target geometry.

In particular, it may be provided that a new target position to be approached is determined from a currently measured distance deviation of an actual distance from a predetermined target distance, for which the deviation would be zero, so that the sensor is tracked along the contour of the component, in particular continuously in a smoothed movement.

The distance-time profile of the corrected measurement movement can, for example, be assigned to a sensor axis, wherein the sensor axis is a controlled axis of the coordinate measuring machine that carries the optical distance sensor.

It may be provided that a respective distance-time profile is calculated according to a cycle of the first cycle frequency by twice integrating a maximum acceleration specified as constant, wherein the maximum acceleration changes its sign once within the cycle in order to indicate an S-shaped course of the distance-time profile.

It is understood that, for two or more axes of the coordinate measuring machine, distance-time profiles can be determined for a respective cycle of the first cycle frequency in order to indicate axis-specific corrected measurement movements, wherein the corrected measuring distance is traversed as a superimposed movement of several machine axes or the corrected measurement movement is generated by superimposed movement of several machine axes.

It may be provided that the determination of the corrected measurement movement is performed only for a single axis of the coordinate measuring machine, namely for the sensor axis that carries the optical distance sensor.

To determine the corrected measurement movement, a distance deviation of the optical sensor can be measured in comparison to a predetermined target distance to the component, wherein the distance deviation is recorded in particular according to the first cycle frequency. The distance deviation can be used together with a specified target distance to calculate a target position for the optical distance sensor to move to, for which the distance deviation would be zero.

In order to avoid susceptibility to vibration, it may be provided that, instead of the distance deviation, the absolute position of the optical distance sensor in the coordinate system of the coordinate measuring machine is used for calculating distance-time profiles.

The optical distance sensor can be a point sensor. The optical distance sensor can be a confocal chromatic distance sensor. The confocal chromatic distance sensor is, in particular, a point sensor.

In particular, individual measuring points can be measured sequentially using the point sensor. Each individual measuring point can be recorded independently and separately from other measuring points using the point sensor. This means that the point sensor can be used to record a single measuring point without simultaneously recording other measuring points. Three spatial coordinates can be assigned to each individual measuring point, e.g., an x-value, a y-value, and a z-value in a Cartesian coordinate system x-y-z.

It may be provided that the point sensor has a depth resolution for optical distance measurement. For example, as viewed along an optical axis of the point sensor, a depth can be measured, i.e., a distance of the optically scanned surface along the optical axis in a predetermined coordinate system, e.g., a distance to an origin of the predetermined coordinate system or to another geometric reference, such as the position of a lens or the like. It may be provided that the distance measurement is performed one-dimensionally along an optical axis and three-dimensional measured values are calculated based on the position of the optical distance sensor in the specified coordinate system.

It may be provided that the depth measurement range covers at least 0.5 mm, in particular at least 2 mm. It may be provided that the depth measurement range is less than 15 mm. In particular, it may be provided that the depth measurement range is greater than or equal to 0.5 mm and less than or equal to 15 mm, in particular greater than or equal to 1.5 mm and less than or equal to 15 mm.

For example, a depth can be measured along an optical axis of the point sensor in a depth measurement range of a few centimeters or a few millimeters or in a depth measurement range of less than one millimeter along the optical axis, i.e., a distance of the optically scanned surface along the optical axis in a predetermined coordinate system can be measured, e.g., a distance to an origin of the predetermined coordinate system or to another geometric reference, such as the position of a lens or the like. In particular, a three-dimensional measuring point can be calculated on the basis of the distance information from the point sensor, wherein information on the axis positions of a coordinate measuring machine carrying the optical point sensor can be taken into account. It may be provided that the distance measurement is performed one-dimensionally along an optical axis and three-dimensional measured values are calculated on the basis of the position of the optical distance sensor.

It may be provided that a focus diameter of the optical distance sensor is 50 micrometers or less, in particular 20 micrometers or less.

By controlling the distance, the measurement accuracy of the optical distance measurement can be improved. Thus, the optical distance sensor can preferably be operated in a section of an existing depth measurement range within which a linearity error of the optical distance sensor is small.

It may be provided that the component is continuously moved relative to the optical distance sensor during the detection of measuring points when traversing the measuring path. In particular, the component may be continuously rotated around an axis while the optical measuring system is fixed and/or moved by means of one or more controlled axes of the coordinate measuring machine.

The corrected measurement movement may have a jump-free travel path, wherein the optical distance sensor is tracked along this jump-free travel path to a contour of the component to be measured.

The jump-free travel path can be composed of travel path segments, wherein the travel path segments can each be described by smooth functions, wherein the travel path segments are determined according to the first cycle frequency, and wherein the jump-free travel path can be described by a smooth function.

In this context, “jump-free” means continuous and smooth in the mathematical sense, i.e., twice differentiable.

During the execution of the corrected measurement movement, acceleration and deceleration may occur, wherein the acceleration is limited by a maximum permissible acceleration and a maximum permissible speed. This means that limit values for the maximum permissible acceleration and the maximum permissible speed can be specified for the movements of the coordinate measuring machine, which must not be exceeded when executing the corrected measurement movement. Axis-specific limit values for the respective permissible maximum acceleration and maximum speed can be specified for each machine axis of the coordinate measuring machine.

The distance can be controlled by means of at least one controlled axis of the coordinate measuring machine, wherein this controlled axis carries the optical distance sensor and wherein this controlled axis can be moved parallel to an optical axis of the optical distance sensor.

During the measurement movement, a distance deviation of the optical sensor compared to a predetermined target distance due to the corrected measurement movement can be less than 2 mm, in particular less than 1 mm, and further in particular less than 0.5 mm.

According to a second aspect, the disclosure relates to a coordinate measuring machine having an optical distance sensor for measuring a component and having a control system, wherein the control system is designed to execute a method according to the disclosure.

### BRIEF DESCRIPTION OF THE DRAWINGS

The disclosure is explained in more detail below with reference to a drawing illustrating an exemplary embodiment. The following figures show schematically:

FIG. 1 shows a coordinate measuring machine according to the disclosure;

FIG. 2 shows an optical distance sensor with a component to be measured with a known contour;

FIG. 3 shows method steps for distance control;

FIG. 4 shows an optical distance sensor with a component to be measured with an unknown contour; and

FIG. 5 shows a distance control of a sensor axis for the unknown contour.

### DETAILED DESCRIPTION OF THE DRAWINGS

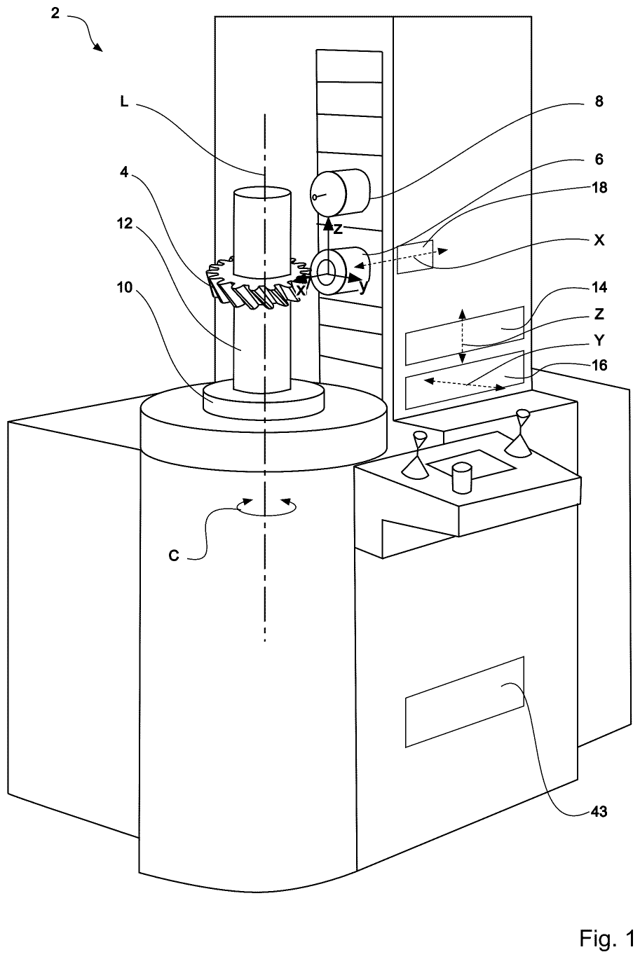

FIG. 1 shows a coordinate measuring machine 2 according to the disclosure for measuring a component 4. In the present illustration, the component 4 is an externally helically toothed spur gear. The coordinate measuring machine 2 has an optical distance sensor 6 for contactless detection of measuring points on the component 4 to be measured and a measuring probe 8 for tactile detection of measuring points on the component 4 to be measured.

The component 4 to be measured is held on a holder 12, which is mounted on a rotary table 10. The component 4 to be measured can be rotated about its longitudinal axis L during measurement by means of the rotary table 10. The rotary table 10 therefore enables a rotary movement, wherein a CNC-controlled rotation axis of the coordinate measuring machine 2 is marked with “C”.

In addition, the coordinate measuring machine has three translational degrees of freedom according to the Cartesian coordinate system x, y, z. This means that the optical distance sensor 6 can be translated by means of controlled drives 14, 16, 18 through a superimposed movement in three spatial directions x, y, z.

Drive 14 is used for the controlled movement of the optical distance sensor 6 in the z-direction and therefore forms a CNC-controlled linear axis of the coordinate measuring machine 2, which is marked with “Z” and enables the movements of the optical distance sensor 6 parallel to the z-axis of the Cartesian coordinate system x, y, z.

Drive 16 is used to control the movement of the optical distance sensor 6 in the y-direction and therefore forms a CNC-controlled linear axis of the coordinate measuring machine 2, which is marked “Y” and enables the movements of the optical distance sensor 6 parallel to the y axis of the Cartesian coordinate system x, y, z.

Drive 18 is used to control the movement of the optical distance sensor 6 in the x-direction and therefore forms a CNC-controlled linear axis of the coordinate measuring machine 2, which is marked with “X” and enables the movements of the optical distance sensor 6 parallel to the x axis of the Cartesian coordinate system x, y, z.

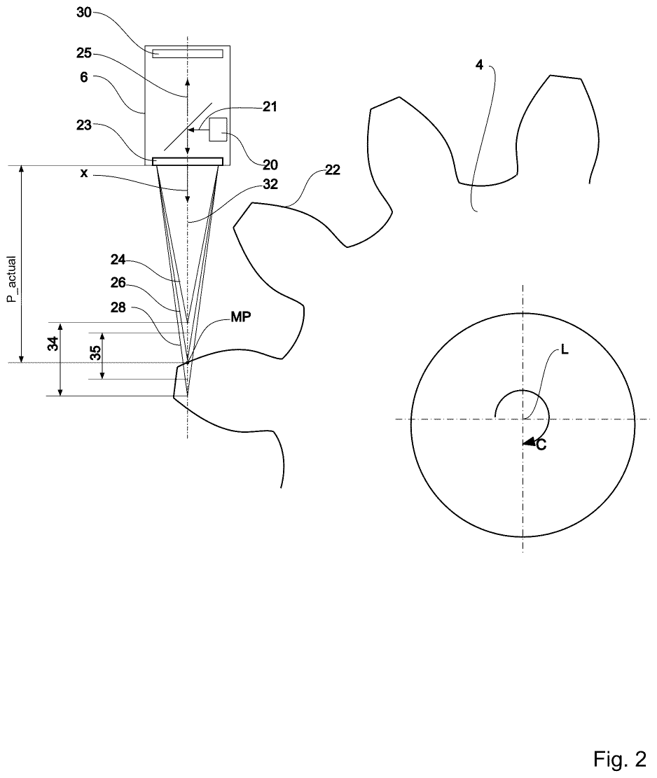

FIG. 2 shows a schematic view of the optical distance sensor 6 and the component 4 in a top view along the axis of rotation or longitudinal axis L.

The optical distance sensor 6 is a confocal chromatic distance sensor. During measurement, component 4 can be rotated around its longitudinal axis L in order to travel a measuring distance. This rotation therefore forms part of the measurement movement. In addition, the optical distance sensor 6 can be moved parallel to the longitudinal axis in the z-direction. This movement also forms part of the measurement movement.

Distance measurement with the confocal chromatic distance sensor 6 works in such a way that light 21 generated by a light source 20 is focused in the direction of a measuring surface 22 of component 4 to be measured. After passing through a lens arrangement 23, the different light colors or wavelengths 24, 26, 28 of the light 21 are focused at different distances from the lens arrangement 23. This means that light components corresponding to the wavelengths 24, 26, 28 are focused at different, known distances from the optical distance sensor 6.

Based on the intensities of the light colors of the light 25 reflected back from component 4, which are detected by a spectrometer 30, the distance P_actual of a measuring point MP on the surface 22 to the optical distance sensor 6 can be determined. In other words, spectral analysis of the reflected light 25 using the spectrometer 30 of the confocal chromatic distance sensor 6 allows the position of an optically detected measuring point MP on the surface 22 to be determined.

The confocal chromatic distance sensor 6 therefore uses the chromatic aberration of the lens arrangement 23 for distance measurement.

The absolute position of the measuring point MP relative to the Cartesian coordinate system x, y, z of the coordinate measuring device is calculated by adding the measured distance P_actual to the current position of the optical distance sensor 6. The current position of the optical distance sensor 6 is determined from the positions of the linear axes X, Y, Z, which can be recorded with high precision, e.g., by means of glass scales assigned to these axes.

The available measuring range 34 of the confocal chromatic distance sensor 6 is determined by the focus points of wavelengths 24, 26, 28 aligned along an optical axis 32 of the optical distance sensor 6. In other words, the available measuring range 34 of the confocal chromatic distance sensor 6 is determined by the fact that wavelengths 24, 26, 28 are focused at different, known distances from the distance sensor 16.

The measuring range 34 can also be referred to as the depth measuring range, since a distance or depth can be measured along the optical axis 32 in the x-direction.

The distance P_actual of the optical distance sensor 6 to the surface 22 to be measured should be controlled during the measurement path in such a way that the surface 22 to be measured is within the available measuring range 34. Preferably, the distance P_actual between the optical distance sensor 6 and the surface 22 to be measured is controlled in such a way that the surface 22 to be measured is located within a section 35 of the available measuring range 34. This is particularly challenging when measuring unknown geometries, as the optical distance sensor 6 must be tracked to an unknown contour of a component to be measured.

The use of only a section 35 of the available measuring range has the advantage that this section 35 has a lower linearity error compared to the use of the entire available measuring range 34. Applying the method according to the disclosure to the optical measurement of a component 4 with a known target geometry, such as the gearing shown in FIG. 2, has the advantage that the measurement accuracy can be increased by using only a section 35 of the available measuring range 34.

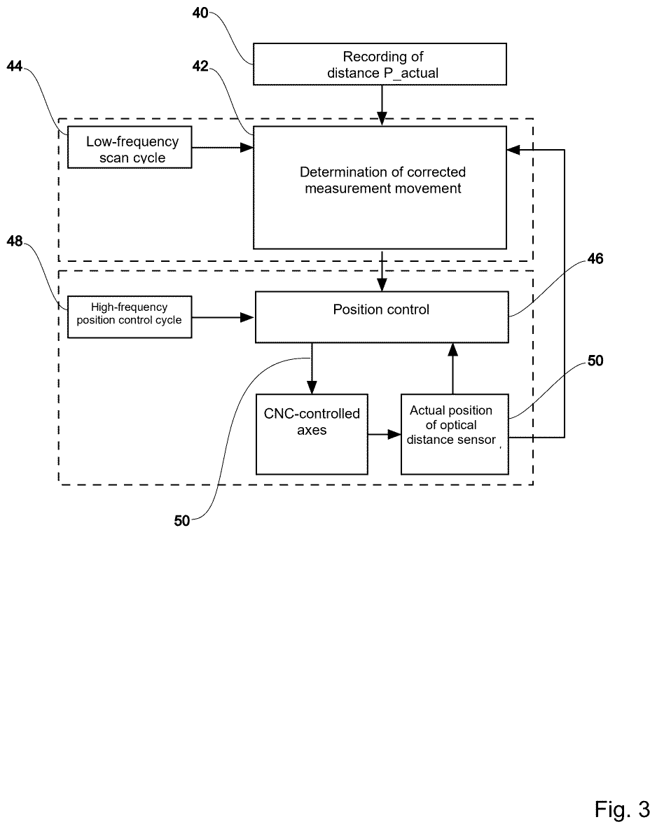

With reference to FIGS. 3, 4, and 5, the scanning of an unknown contour K of a component B is described below by way of example and schematically, wherein the basic operating principle of this distance control also applies to the optical measurement of components with a known target geometry.

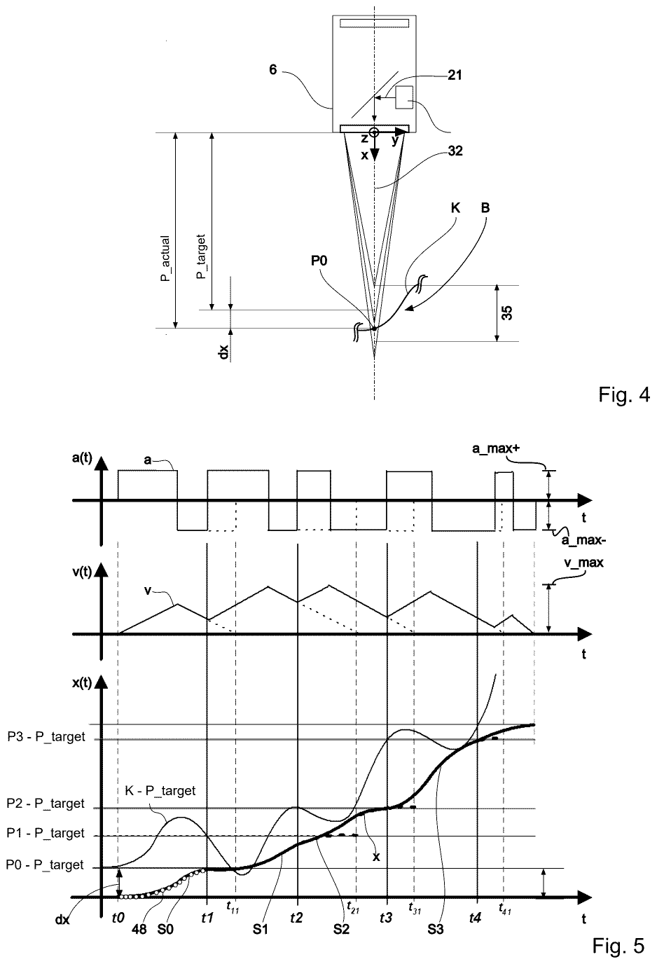

During scanning or scanning measurement, the optical distance sensor 6 follows the unknown contour K to be measured at a distance in the x-direction (FIG. 4). This distance is to be controlled to the target distance P_target.

The course of the unknown contour K in the x-direction minus the target distance P_target is shown in FIG. 5 as curve K−P_target (in words: K minus P_target), wherein curve x represents the position of the distance sensor 6 in the x-direction. As can be seen in FIG. 5, the distance sensor 6 does not follow the contour K exactly, but only approximately according to a corrected measurement movement x. In this case, the distance sensor 6 tracks the measuring points P0, P1, P2, P3, which lie on the unknown contour K, in segments within the time intervals t0-t1, t1-t2, t2-t3, t3-t4. The measuring point P0 is shown as an example in FIG. 4.

In other words, the measuring points P0, P1, P2, P3, whose x-position is calculated from the x-position of the distance sensor 6 plus the measured distance P_actual, lie on the contour K to be traversed, wherein the distance sensor 6 tracks these measuring points P0, P1, P2, P3 in the x-direction in such a way that the measurement points of the contour K to be detected are located within the section 35 of the available measuring range of the optical distance sensor 6. This allows a precise measurement of the contour K to be made.

The overall measurement movement can be a superimposed relative movement with movement components in the y-direction and z-direction, wherein only the control of the distance and the determination of a corrected measurement movement in the x-direction are discussed below by way of example and schematically. However, the distance can also be controlled by superimposed movements of the CNC-controlled axes X, Y, Z, and C of the coordinate measuring machine 2, so that a respective corrected measurement movement can be specified for each of the CNC-controlled axes X, Y, Z, and C of the coordinate measuring machine 2 in an axis-specific manner.

In FIG. 5, “a” denotes the curve for the acceleration a(t), “v” denotes the curve for the velocity v(t), and x denotes the curve x(t) for the position of the optical distance sensor 6 in the x-direction—each plotted over time t. As already discussed, the curve K−P_target (in words: K minus P_target) within the coordinate system x(t) describes the course of the unknown contour K to be measured in the x-direction, which is recorded over time t when traversing the measuring path, minus the target distance P_target.

FIG. 5 shows four scan cycles t0-t1, t1-t2, t2-t3, t3-t4 (in words: t0 to t1, t1 to t2, t2 to t3, t3 to t4). The positions P0−P_target (in words: P0 minus P_target) to P3−P_target (in words: P3 minus P_target) are calculated target positions in the x-direction for the corrected measurement movement, which are to be approached using the optical distance sensor 6. The points 48 on the curve x=x(t) show examples of positions of the distance sensor 6 in the x-direction as a function of time t. Each point 48 on the curve x=x(t) can be regarded as a calculated target position for a position controller of the linear axis X.

FIG. 4 shows the optical distance sensor 6 with a section of the unknown contour K to be measured. For example, it may be provided that the optical distance sensor 6 is moved by a relative movement in the y-direction along the unknown contour K in order to scan it. During this scanning movement in the y-direction, the distance control described here takes place in the x-direction.

FIG. 3 shows the method steps of the method according to the disclosure. All method steps of the method can be performed on a computer or a control 43 of the coordinate measuring machine 2.

One method step 40 involves detecting the actual distance P_actual measured by the optical distance sensor 6. This measured actual distance P_actual is transferred to a method step 42, which involves determining the corrected measurement movement. The determination of the corrected measurement movement is carried out according to a low-frequency scan cycle, which is specified, for example, as a repeating time signal by a clock generator 44.

The result of the repeated determination of corrected measurement movements in accordance with the low-frequency scan cycle are, for example, the path-time segments S0-S3 shown in FIG. 5, which have been calculated for four scan cycles t0-t1, t1-t2, t2-t3, t3-t4 of the low-frequency scan cycle.

The low-frequency scan cycle can consist, for example, of repeating scan or time intervals of 50 ms (milliseconds) each. This means that the time span t0-t1 is 50 ms in the present example. Similarly, the time spans t0-t1, t1-t2, t2-t3, t3-t4 are each 50 ms. This corresponds to a first cycle frequency of 20 Hz (Hertz).

As can be seen in FIG. 3, the respective corrected measurement movement calculated according to the low-frequency scan cycle is transferred to a position control 46 of the linear axis X of the coordinate measuring machine. The position control 46 operates at high frequency according to a high-frequency position control cycle specified by a clock generator 48.

The cycle frequency of the position control 46, which can also be referred to as the second cycle frequency, is thus greater than the cycle frequency of the low-frequency scan cycle 44, which can also be referred to as the first cycle frequency. In this context, “high frequency” means that the position control 46 controls at time intervals that are significantly shorter than the time intervals of the low-frequency scan cycle. For example, the time intervals of the position control can be 1 ms. This corresponds to a second cycle frequency of 1000 Hz.

FIG. 5 shows, by way of example and schematically, support points 48 for segment S0 according to the time interval t0-t1 as bright diamonds along the curve x(t), wherein the position control 46 controls a position of the distance sensor in the x-direction relative to these support points 48. The segments S0-S3 can be referred to as travel path segments. The curve x can be referred to as the travel path. An actual position of the distance sensor 6 in the x-direction is detected in accordance with FIG. 3 in method step 50 and transferred to the position control 46 and to method step 42, which concerns the determination of the corrected measurement movement.

The position control 46 of the optical distance sensor 6 uses the specified current setpoint or support point 48 of the corrected measurement movement x(t) and the actual position of the distance sensor 6, a control signal 50 is determined with which the linear drive X is controlled in order to position the distance sensor 6 according to the setpoint position 48 that is provided in accordance with the corrected measurement movement in the x-direction.

As can be seen in FIG. 5, the movements of the distance sensor 6 in the x-direction take place in compliance with limit values for a maximum permissible positive and negative acceleration a_max+ and a_max−, as well as a maximum permissible speed v_max. Specifying these limit values can reduce the risk of vibration excitation or oscillation during measurement operation.

The aim of the method according to the disclosure is to guide the optical distance sensor 6 in the x-direction at a distance P_target relative to the unknown contour K so that the contour K is detected within the section 35 of the available measuring range. It is deliberately accepted that the low-frequency scan cycle causes a distance deviation dx within the limits of the section 35 in order to avoid transferring short-wave sections of the contour K to the axis kinematics.

The method according to the disclosure comprises the following method steps in particular:
Measurement of absolute positions P0, P1, P2, P3, etc. of the unknown contour K in the Cartesian coordinate system x, y, z of the coordinate measuring machine 2. These absolute positions P0, P1, P2, P3 result from the position of the optical distance sensor 6 in the Cartesian coordinate system x, y, z of the coordinate measuring machine 2 and the respective measured actual distance P_actual in the x-direction.
Segment-by-segment calculation of a corrected measurement movement for the linear axis X, which can also be referred to as the sensor axis, wherein the optical distance sensor 6 is tracked to the unknown contour K. Here, the current speed and current acceleration at the time of determining the corrected measurement movement can be taken into account, as well as compliance with the specified limit values for acceleration and speed.
Execution of the corrected measurement movement in compliance with the specified limits for acceleration and speed.
Detecting the contour K during the execution of the corrected measurement movement on the basis of measured distances P_actual.

It is understood that the Cartesian coordinate system can be defined at any point on the coordinate measuring machine 2. The arrangement shown in FIG. 5 is merely an example and is intended to simplify the description.

FIG. 5 shows the movement of the optical distance sensor 6 in the x-direction as a function of time t, using the example of four time intervals t0-t1, t1-t2, t2-t3, t3-t4 of the low-frequency scan cycle.

To simplify the representation, the first time interval t0-t1 begins at time to with x(t0)=0 and v(t0)=0. A specified target value for the target distance P_target of the distance sensor 6 in the x-direction is constant for the entire period t0 to t4 under consideration.

The method step 42, which concerns the determination of the corrected measurement movement, uses a measured distance deviation dx, i.e., the difference between P_actual and P_target, or the measured distance P_actual, and the absolute position of the optical distance sensor 6 in the x-direction relative to the Cartesian coordinate system x, y, z of the coordinate measuring device 2. This means that the absolute position of the measuring point P0 of the contour in the x-direction is calculated at time to from the absolute position of the optical distance sensor 6 in the x-direction and from the measured distance P_actual in the x-direction.

In general, the objective is to move the optical distance sensor 6 in the x-direction using the linear axis X in such a way that the measurement points of the contour K to be detected are located within the section 35 of the available measurement range. It is deliberately accepted that a distance deviation dx will occur due to the delayed tracking of the optical sensor 6 in accordance with the low-frequency scanning cycle. This is because the optical distance sensor 6 will always lag behind the unknown contour K due to the proposed distance control based on previously measured positions.

By definition of the Cartesian coordinate system shown in FIG. 4, if the point P0 of the unknown contour K were located exactly at the target distance P_target relative to the optical distance sensor 6 in the x-direction at time to, the distance deviation dx would be zero at time t0. However, this is not the case in the present instance, as can be seen in FIG. 4 and FIG. 5. The absolute position of point P0 in the x-direction is given by the x-position of the optical distance sensor 6 at time to (in this case x=0) plus the distance P_actual measured at time t0. The distance deviation dx at time to is therefore calculated from the difference of P0 minus P_target, which is marked in FIG. 5 as position P0−P_target (in words: P0 minus P_target) on the x-axis.

As already mentioned, the measured absolute position of the measuring point P0 of the unknown contour K in the x-direction is an input variable for determining the corrected measurement movement for the interval t0-t1 according to method step 42.

According to method step 42, a distance-time curve S0, i.e., a travel distance segment S0, can be calculated for the time interval t0-t1, e.g., by twice integrating the specified maximum accelerations a_max+ and a_max−.

As shown by the curve a(t) in FIG. 5, the optical distance sensor 6 of the controlled linear axis X is first accelerated with a_max+ and then braked with a_max−, so that the velocity curve v(t) initially rises linearly and then falls linearly in the period t0-t1.

As a result, the corresponding distance-time curve x(t) or S0 has an S-shape. In particular, it may be provided that the optical distance sensor 6 reaches its target position P0−P_target (in words: P0 minus P_target), i.e., the measuring point P0 of the contour K minus the target distance P_target, as quickly as possible, but that its movement should end at time t11 at a speed of v=0.

Based on the calculated initial distance-time curve S0, the optical distance sensor 6 would reach the target position P0−P_target (in words: P0 minus P_target) in the x-direction at time t11. However, as FIG. 5 shows, the current time interval t0-t1 already ends at time t1, i.e., before time t11.

At this moment t1, a new distance-time curve S1 is already determined for the second time interval t1-t2 in accordance with the scan cycle, i.e., a further corrected measurement movement is determined. To this end, in method step 42, the measured absolute position of the measuring point P1 of the contour K is determined in the same way as before, and the computer 43 calculates the distance-time curve S1 by integrating a(t) twice for t1-t2. Furthermore, the current position and current velocity of the optical distance sensor 6, which it has reached at time t1, are also taken into account. As a result, the second distance-time curve S1 connects tangentially to the first distance-time curve S0 at time t1. The movement of the optical distance sensor 6 therefore follows a continuous, smooth distance profile and would end at time t21 at position P1−P_target (in words: P1 minus P_target) with a speed of v=0.

However, here too, the optical distance sensor 6 does not reach position P1−P_target (in words: P1 minus P_target) at time t21 because the time interval t1-12 of the second scan cycle ends before time t21.

At time t2, the third distance—time curve S2 thus joins curve S1—again in a smooth and continuous transition. At time t2, in accordance with method step 42, the measured absolute position of measuring point P2 of contour K is therefore recorded again and calculated in the corrected measurement movement described above. This applies equally to the interval t3-t4.

FIG. 5 shows that the path x, according to the low-frequency corrected measurement movement, replicates the contour K with a certain amount of damping or smoothing. This is achieved in accordance with the disclosure by decoupling of the measurement of the distance deviation from the position control and by the low-frequency scan cycle.

The measured absolute positions P0, P1, P2, P3 of the contour are only recorded once per scan cycle to determine the corrected measurement movement, i.e., every 50 ms, for example. In contrast, the individual support points 48 on the curve x are determined much more frequently and corrected by the linear axis X, for example every 1 ms. This means that, due to the high-frequency cycle of the position control, the optical distance sensor 6 does not move with absolute precision due to the high-frequency cycle of position control, but always very close to a smooth curve calculated by integration in accordance with the corrected measurement movement. Its course is adapted to the actual contour K at comparatively large time intervals without transferring jumps or other disturbances of the contour K to the path curve x of the corrected measurement movement. As already mentioned, distance deviations dx are therefore accepted in order to transfer short-wave-like profile contours to the axis kinematics of the coordinate measuring machine 2. The distance sensor 6 is therefore tracked to the contour K with a jump-free, smoothed movement that corresponds to a smoothed shape of the contour K.

1. A method including the following steps:
measuring a component using an optical distance sensor of a coordinate measuring machine, wherein a measuring path is traversed by way of a measurement movement; and
controlling a distance between the optical distance sensor and the component during the measurement;
wherein
the control of the distance comprises determining a corrected measurement movement according to a first cycle frequency, and
the control of the distance comprises position control for traversing the corrected measurement movement according to a second cycle frequency, wherein the second cycle frequency is greater than the first cycle frequency.

2. The method according to claim 1,
wherein the determination of the corrected measurement movement for a respective cycle of the first cycle frequency comprises the determination of a distance-time profile,
wherein a cycle time of the first cycle is shorter than a time span of the determined distance-time profile, so that a further corrected measurement movement with a further distance-time profile is already determined before an end of the previously determined distance-time profile has been reached.

3. The method according to claim 1,
whereby for determining the corrected measurement movement, a distance deviation of the optical sensor is measured in comparison to a predetermined target distance to the component, wherein the distance deviation is recorded according to the first cycle frequency.

4. The method according to claim 1,
wherein the optical distance sensor is a confocal chromatic distance sensor.

5. The method according to claim 1,
wherein the corrected measurement movement has a jump-free travel path, wherein the optical distance sensor is tracked along this jump-free travel path to a contour of the component to be measured.

6. The method according to claim 5,
wherein the jump-free travel path is composed of travel path segments, wherein the travel path segments are each described by smooth functions, wherein the travel path segments are determined according to the first cycle frequency, and wherein the jump-free travel path is described by a smooth function.

7. The method according to claim 1,
whereby acceleration and deceleration occur during the execution of the corrected measurement movement, wherein the acceleration is limited by a maximum permissible acceleration (a_max+, a_max−) and a maximum permissible speed (v_max).

8. The method according to claim 1,
wherein the distance is controlled by way of at least one controlled axis of the coordinate measuring machine, wherein this controlled axis carries the optical distance sensor and wherein this controlled axis can be moved parallel to an optical axis of the optical distance sensor.

9. The method according to claim 1,
whereby during the measurement movement, a distance deviation of the optical distance sensor compared to a predetermined target distance due to the corrected measurement movement is less than 2 mm.

10. A coordinate measuring machine comprising: an optical distance sensor for measuring a component and a control system, wherein the control system is designed to execute a method according to claim 1.
